(19) United States
(12) Patent Application Publication
(10) Pub. No.: US 2009/0327812 A1
(43) Pub. Date: Dec. 31, 2009

(54) METHOD, DEVICE AND COMPUTER ACCESSIBLE MEDIUM FOR SECURE ACCESS PROTOCOL CONFORMANCE TESTING ON AUTHENTICATION SERVER

(76) Inventors: Bianling Zhang, Shaanxi (CN); Jun Cao, Shaanxi (CN); Xuefeng Tu, Shaanxi (CN)

Correspondence Address: DORSEY & WHITNEY LLP;INTELLECTUAL PROPERTY DEPARTMENT, 250 PARK AVENUE, NEW YORK, NY, 10177, US

(21) Appl. No.: 12/281,137

(22) PCT Filed: Feb. 27, 2007
(86) PCT No.: PCT/CN07/00637

§ 371 Date: Apr. 14, 2009

(30) Foreign Application Priority Data
Feb. 28, 2006 (CN) 200610041849.9

(51) Int. Cl. G06F 11/28; G06F 21/20

(52) U.S. Cl. 714/32; 726/3; 714/E11.178

(57) ABSTRACT

Exemplary embodiments of a method, device and computer-accessible medium for secure access protocol conformance testing on an authentication service entity can be provided. According to one exemplary embodiment, it is possible to determine whether a certificate issued by the authentication service entity to be tested complies with a corresponding specification of a standard. An authentication requester can be simulated to send a certificate authentication request message to the authentication service entity to be tested. A certificate authentication response fed back from the authentication service entity to be tested can be captured. Further, a secure access protocol conformance testing result on the authentication service entity to be tested can be obtained by analyzing the certificate authentication response.

### CROSS-REFERENCE TO RELATED APPLICATION(S)

This application is a national stage application of PCT Application No. PCT/CN2007/0000637 which was filed on Feb. 28, 2007, and published on Sep. 7, 2007 as International Publication No. WO 2007/098694 (the “International Application”). This application claims the priority from the International Application, pursuant to 35 U.S.C. §365, and from Chinese Patent Application No. 200610041849.9 filed Feb. 28, 2006, pursuant to 35 U.S.C. §119. The disclosures of the above-referenced applications are incorporated herein by reference in their entities.

### FIELD OF THE PRESENT INVENTION

The present invention relates to secure network access protocol testing, and in particular to a method and an apparatus for secure access protocol conformance testing on an authentication service entity.

### BACKGROUND INFORMATION

Internet Protocol (IP) based networks support an increasing number of types of services and have been involved in various aspects of national economy and society. Wireless IP based networks transmit data through radio waves, which brings physical openness of the networks to a new level. Therefore, secure access is becoming a key issue in secure operation of wired and wireless networks.

A secure access system of an IP network mainly involves three network entities: a network terminal, an access point (AP) and an authentication service entity. The network terminal requests to access the network and enjoys various resources that the network provides; the access point is an edge device of the IP network and an entity providing access service for the network terminal; and the authentication service entity is an entity providing user identity authentication service.

Currently, secure access protocol conformance testing systems for products in the field of wireless local area network mainly include interoperability testing systems, and assisting management testing systems which are applied in some wireless local area networks. Particularly, an assisting management testing system provides information relating to network system installation and application by monitoring statuses of a physical channel and the network. An interoperability testing system verifies the correctness of the realization of a protocol on a device to be tested by testing the interconnectability between the device to be tested and a reference device and performance of intercommunication, i.e., a protocol conformance test.

The above-described existing interoperability testing system performs conformance tests in a typical application environment, and e.g., to deduce the correctness of the realization of a lower layer protocol by verifying the interconnectability of a upper layer protocol between a reference device and a device to be tested. Hence, such testing is likely incomplete and may lead to a testing result in error. Furthermore, a testing result can be determined based on the interconnectability and performance of intercommunication between a reference device and a device to be tested, so that the correctness of the implementation of the reference device will affect the accuracy of the testing result; and it'll be difficult for a tester to obtain error locating information.

### SUMMARY OF EXEMPLARY EMBODIMENTS OF THE PRESENT INVENTION

One of the objectives of the present invention is to provide a method and device for secure access protocol conformance testing on an authentication service entity.

An exemplary embodiment according to the present invention provides a method for a secure access protocol conformance testing on an authentication service entity. Such exemplary method includes the following procedures:
checking whether a certificate issued by the authentication service entity to be tested complies with a corresponding specification of a standard;
simulating an authentication requester to send a certificate authentication request message to the authentication service entity to be tested;
capturing a certificate authentication response fed back from the authentication service entity to be tested; and
obtaining a secure access protocol conformance testing result on the authentication service entity to be tested by analyzing the certificate authentication response.

For example, the procedure of sending a certificate authentication request message can include sending a variety of certificate authentication request messages including a combination of validity statuses of the certificate.

For example, the certificate issued by the authentication service entity to be tested can include a terminal certificate and an access point certificate, and the combination of validity statuses of the certificate particularly is a combination of a variety of statues such as “valid” and “revoked”, of the access point certificate and the terminal certificate.

For example, the certificate issued by the authentication service entity to be tested can include an access point certificate and a terminal certificate, and the authentication requester may be an access point. Further, the certificate authentication request message can contain the terminal certificate and the access point certificate issued by the authentication service entity to be tested. The certificate authentication response can include an authentication result upon authentication of the access point certificate and the terminal certificate by the authentication service entity to be tested.

For example, the procedure of checking whether a certificate issued by the authentication service entity to be tested complies with a corresponding specification of a standard can include:
checking whether a value of a version number field in the certificate issued by the authentication service entity to be tested complies with a corresponding specification of the standard;
checking whether a length and content of a serial number field in the certificate issued by the authentication service entity to be tested complies with a corresponding specification of the standard;
checking whether a hashing algorithm/procedure of a signature algorithm field and a value of a signature algorithm/procedure sub-field in the certificate issued by the authentication service entity to be tested complies with a corresponding specification of the standard;
checking whether values of length sub-fields and lengths of content sub-fields of a certificate issuer name field, a certificate holder name field, a certificate holder public key field and a issuer signature field in the certificate issued by the authentication service entity to be tested are the same; and
checking whether a length of a validity period field in the certificate issued by the authentication service entity to be tested complies with a corresponding specification of the standard.

For example, the certificate authentication response can include a terminal certificate authentication result and an access point certificate authentication result. The procedure of analyzing the certificate authentication response can include:
checking whether a version number of the certificate authentication response complies with a corresponding specification of the standard;
checking whether a value of a data length field in the certificate authentication response complies with a length of a data field;
determining by comparison whether content of a terminal certificate validity status field of an information field of the terminal certificate authentication result is the same as a validity status of a locally stored terminal certificate, and whether a value of a code field of the terminal certificate authentication result is within a range defined in the standard;
determining by comparison whether content of an access point certificate validity status field of an information field of the access point certificate authentication result is the same as a validity status of a locally stored access point certificate, and whether a value of a code field of the access point certificate authentication result is within a range defined in the standard; and
determining by comparison whether a value of a length sub-field and a length of a content sub-field of an authentication service entity signature field in the certificate authentication response are the same, and whether they are the same as a valid length value specified in the standard.

For example, the exemplary embodiment of the method further can include a procedure of storing locally the certificate issued by the authentication service entity to be tested and its validity status.

For example, the secure access protocol can include the WAPI (Wireless Local Area Network Authentication and Privacy Infrastructure) protocol.

According to another exemplary embodiment of the present invention, a method can be provided for secure access protocol conformance testing on an authentication service entity. Such exemplary method can include the following procedures:
storing a certificate with a particular validity status, which is issued by the authentication service entity to be tested, and checking whether the certificate complies with a corresponding specification of a standard;
capturing an authentication result of the certificate, which is sent by the authentication service entity to be tested;
performing a conformance analysis on the authentication result according to content of the stored certificate and a specification of the standard; and
determining whether the secure access protocol conformance testing on the authentication service entity to be tested is passed based on a checking conclusion of the certificate and an analysis conclusion of the authentication result of the certificate.

For example, the procedure of determining whether the secure access protocol conformance testing on the authentication service entity to be tested is passed based on a checking conclusion of the certificate and an analysis conclusion of the authentication result of the certificate can include, e.g., (i) if the stored certificate issued by the authentication service entity to be tested complies with a corresponding specification of the standard, and the authentication result of the certificate complies with the content of the stored certificate and a corresponding specification of the standard, then determining that the secure access protocol conformance testing on the authentication service entity to be tested is passed; and (ii) otherwise, determining that the secure access protocol conformance testing on the authentication service entity to be tested is failed.

For example, the procedure of capturing the authentication result sent by the service entity includes: (i) simulating an authentication requester to send to the authentication service entity to be tested a certificate authentication request message containing the stored certificate with the particular validity status; and (ii) receiving a certificate authentication response fed back from the authentication service entity to be tested, which includes at least an authentication result of the certificate contained in the authentication request message.

For example, the certificate issued by the authentication service entity to be tested can include a terminal certificate and an access point certificate, the authentication requester can be an access point, and the authentication result of the certificate can include an authentication result of the access point certificate and an authentication result of the terminal certificate.

For example, a conformance of the certificate authentication result and the content of the stored certificate can include: a validity status of the certificate in the certificate authentication result complies with a validity status of the stored certificate.

According to still another exemplary embodiment of the present invention can provide a device for secure access protocol conformance testing on an authentication service entity. Such exemplary device can include:
a certificate storage unit adapted to locally store a certificate with a particular validity status issued by the authentication service entity to be tested;
a certificate checking unit adapted to check whether the certificate stored in the storage unit complies with a corresponding specification of a standard;
a certificate authentication result capture unit adapted to capture an authentication result of the certificate, which is sent by the authentication service entity to be tested;
a certificate authentication result analysis unit adapted to check and analyze the authentication result of the certificate according to content of the locally stored certificate and a specification of the standard; and
a testing result determination unit adapted to determine whether the secure access protocol conformance testing on the authentications service entity to be tested is passed based on a checking conclusion by the certificate checking unit and an analysis conclusion by the certificate authentication result analysis unit.

If the checking conclusion by the certificate checking unit is that the certificate issued by the authentication service entity to be tested complies with the corresponding specification of the standard, and the analysis conclusion by the certificate authentication result analysis unit is that the authentication result of the certificate complies with the contents of the locally stored certificate and the corresponding specification of the standard, then a testing result determined by the testing result determination unit can be that the secure access protocol conformance testing on the authentications service entity to be tested is passed; otherwise the determined testing result is likely failed.

For example, the certificate authentication result capture unit can include: a certificate authentication request simulation sub-unit, configured to simulate an authentication requester to send to the authentication service entity to be tested an authentication request message containing the locally stored certificate with the particular validity status; and a certificate authentication result reception sub-unit configured to receive a certificate authentication response fed back from the authentication service entity to be tested, which can include at least an authentication result of the certificate contained in the authentication request message.

For example, the certificate authentication result analysis unit can include:
a first analysis sub-unit adapted to determine by comparison whether the authentication result of the certificate complies with the content of the locally stored certificate, which at least including determining by comparison whether a certificate validity status in the certificate authentication result complies with the a validity status of the stored certificate; and
a second analysis sub-unit, adapted to determine by comparison whether the certificate authentication result complies with a corresponding specification of the standard.

For example, the certificate issued by the authentication service entity to be tested can include a terminal certificate and an access point certificate, the authentication requester may be an access point, and the certificate authentication result can include an authentication result of the access point certificate and an authentication result of the terminal certificate.

The exemplary embodiments of the present invention can be based upon authentication service entities and can be used to test the correctness and conformance of the realization of a secure access protocol for an authentication service entity made by a device manufacturer. On one hand, the certificate with a particular validity status issued by the authentication service entity to be tested can be checked to determine whether it complies with a corresponding specification of a standard, on the other hand, the captured authentication result of the certificate sent by the authentication service entity to be tested may be analyzed, thereby determining whether the secure access protocol conformance testing on the authentication service entity to be tested is passed. It can be seen, the conformance conclusion in the solution of the present invention is drawn from a direct analysis of a certificate and a authentication result of the certificate, instead of other reasoning, therefore the correctness and conformance of the realization of a secure access protocol on the authentication service entity can be ensured.

Further, exemplary embodiments of computer accessible medium can be provided which can be implemented in accordance with the exemplary embodiments of the methods and systems of the present invention as described herein above.

Furthermore, since the exemplary solution of the exemplary embodiments of the present invention can perform an item-by-item analysis of a certificate itself issued by an authentication service entity to be tested and an fed back authentication result of the certificate, detailed error locating information can be provided in case the test is failed.

### BRIEF DESCRIPTION OF THE DRAWINGS

Further objects, features and advantages of the invention will become apparent from the following detailed description taken in conjunction with the accompanying figure showing illustrative embodiment(s), result(s) and/or feature(s) of the exemplary embodiment(s) of the present invention, in which:

FIG. 1 is a topological diagram of an exemplary embodiment of a system for secure access protocol conformance testing on an authentication service entity according to the present invention;

FIG. 2 is a flow diagram of an exemplary embodiment of a method for secure access protocol conformance testing on an authentication service entity according to the present invention; and

FIG. 3 is a block diagram of an exemplary embodiment of a device for secure access protocol conformance testing on an authentication service entity according to the present invention.

Throughout the figures, the same reference numerals and characters, unless otherwise stated, are used to denote like features, elements, components or portions of the illustrated embodiments. Moreover, while the present invention will now be described in detail with reference to the figures, it is done so in connection with the illustrative embodiments.

### DETAILED DESCRIPTION OF EXEMPLARY EMBODIMENTS

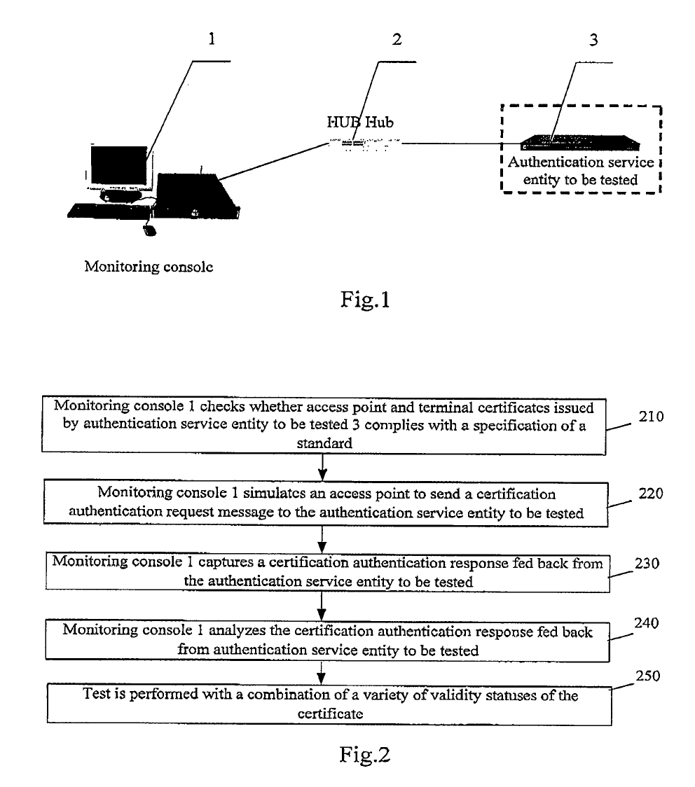

Exemplary embodiments of methods according to the present invention can be applicable to WAPI protocol (Wireless Local Area Network Authentication and Privacy Infrastructure). The solutions according to the exemplary embodiments of the present invention may be applicable to a system structure as illustrated in FIG. 1, which can include a monitoring console 1, a hub 2 and an authentication service entity to be tested 3, where the monitoring console 1 and the authentication service entity to be tested 3 intercommunicate via the hub 2.

A exemplary implementation of the exemplary embodiments of the present invention are described below with regard to the exemplary system shown in FIG. 1, and a detail flow diagram of the exemplary method as illustrated in FIG. 2.

Turning to FIGS. 1 and 2 and the exemplary arrangements and procedures provided therein, a description of the procedure indicated in step 210 is described: For example, in such procedure/step 210, the monitoring console 1 can check whether access point and terminal certificates issued by the authentication service entity to be tested 3 comply with a specification of a standard. For example, the access point certificate and the terminal certificate issued by the authentication service entity to be tested 3 are installed in the monitoring console 1. Further, the monitoring console 1 can check and analyze the access point certificate and the terminal certificate issued by the authentication service entity to be tested 3 according to a format specified in the standard. The monitoring console 1 can store validity statuses of the access point certificate and the terminal certificate issued by the authentication service entity to be tested 3 while installing the certificates, and a validity status of a certificate refers to the legality of the certificate (e.g., the certificate is valid) or illegality of the certificate (e.g., the certificate has been revoked).

For example, the step 210 can include sub-steps 310 to 350. Particularly, in sub-step 310, the monitoring console 1 can check whether values of version number fields in the certificates issued by the authentication service entity to be tested 3 comply with values specified in the standard. Indeed, it may be preferable to check whether a value of a version number field in the terminal certificate issued by the authentication service entity to be tested 3 complies with a value specified in the standard and whether a value of a version number field in the access point certificate issued by the authentication service entity to be tested 3 complies with a corresponding specification in the standard.

Turning to sub-step 320, the monitoring console 1 may check whether lengths and contents of respective serial number fields in the access point certificate and the terminal certificate issued by the authentication service entity to be tested 3 comply with corresponding specifications in the standard. With respect to sub-step 330, the monitoring console 1 may check whether hashing algorithms and values of signature algorithm sub-fields of respective signature algorithm fields in the access point certificate and the terminal certificate issued by the authentication service entity to be tested 3 comply with corresponding specifications in the standard.

As to sub-step 340, the monitoring console 1 can check whether values of length sub-fields and lengths of content sub-fields in respective certificate issuer name fields, certificate holder name fields, certificate holder public key fields and issuer signature fields in the access point certificate and the terminal certificate issued by the authentication service entity to be tested 3 comply with corresponding specifications in the standard. With respect to sub-step 350, the monitoring console 1 checks whether lengths of respective validity period fields in the access point certificate and the terminal certificate issued by the authentication service entity to be tested 3 comply with corresponding specifications in the standard.

Step 220: The monitoring console 1 simulates an access point to send a certificate authentication request message to the authentication service entity to be tested. Particularly, the monitoring console 1 simulates the access point to create the certificate authentication request message particularly including the terminal certificate and the access point certificate to be authenticated.

Next, turning to another procedure/step 230, in this procedure/step, the monitoring console 1 can capture a certificate authentication response fed back from the authentication service entity to be tested 3. Upon reception of the certificate authentication request message sent by the monitoring console 1, the authentication service entity to be tested 3 can feed back the certificate authentication response to the monitor console 1 including an authentication result of the terminal certificate and an authentication result of the access point certificate. The authentication result of the terminal certificate likely refers to a validity status of the terminal certificate to be authenticated in the certificate authentication request message, and the authentication result of the access point certificate likely refers to a validity status of the access point certificate to be authenticated in the certificate authentication request message. The validity status of a certificate can refer to the legality of the certificate (e.g., the certificate is valid) or illegality of the certificate (e.g., the certificate has been revoked).

For procedure/step 240, the monitoring console 1 can analyze the certificate authentication response fed back from the authentication service entity to be tested. The procedure/step 240 can include sub-steps 410 to 450, as follows. For example, in sub-step 410, the monitoring console 1 can check whether a version number of the certificate authentication response fed back from the authentication service entity to be tested complies with a corresponding specification in the standard. For sub-step 420, the monitoring console 1 can check whether a value of a data length field of the certificate authentication response fed back from the authentication service entity to be tested complies with a corresponding specification in the standard. Further, with respect to sub-step 430, the monitoring console 1 can determine by comparison whether content of a terminal certificate field in an information field of the authentication result of the terminal certificate (e.g., the validity status of the terminal certificate) are the same as the validity status of a locally stored terminal certificate and whether a value of a code field of the authentication result of the terminal certificate is within a range specified in the standard.

As an example, it may be assumed that in the procedure/step 210, the validity status of a terminal certificate issued by the authentication service entity to be tested 3 and installed at the monitoring console 1 is “revoked.” In addition, it can be assumed this terminal certificate with the validity status of “revoked will be referred to as first terminal certificate below for convenience, e.g., the status of the first terminal certificate, which is stored locally at the monitoring console 1, is “revoked”. Further in procedure/step 220, the certificate authentication request message sent by the monitoring console 1 to the authentication service entity to be tested 3 can include the first terminal certificate. Thereafter, in the sub-step 430, if the monitoring console 1 parses the information field of the authentication result of the terminal certificate and determines the validity status of the first terminal certificate to be “valid”, then it is likely different from the validity status “revoked” of the first terminal certificate locally stored (i.e., at the monitoring console 1); on the contrary, if the validity status of the first terminal certificate parsed from the information field of the authentication result of the terminal certificate is “revoked”, then it is the same as the validity status “revoked” of the locally stored first terminal certificate.

With respect to sub-step 440, the monitoring console 1 can determine by comparison whether content of an access point certificate authentication result field in an information field of the authentication result of the access point certificate (e.g., the validity status of the access point certificate) are likely the same as a validity status of a locally stored access point certificate and whether a value of a code field of the authentication result of the access point certificate is within a range specified in the standard. An exemplary implementation of the analysis of the authentication result of the access point certificate in sub-step 440 can be similar to that of analyzing the authentication result of the terminal certificate in the sub-step 430, and therefore the repeated description thereof is omitted. Further, for sub-step 450, the monitoring console 1 can determine by comparison whether a value of a length sub-field and a length of a content sub-field in an authentication service entity signature field in the certificate authentication response fed back from the authentication service entity to be tested 3 are likely the same and whether they comply with a valid length value specified in the standard.

Additionally, turning to procedure/step 250 of FIG. 2, a testing with a combination of a variety of validity statuses of the certificates can further be performed to make the testing more comprehensive. For example, in the certificate authentication request message sent by the monitoring console 1 while it is simulating an access point to the authentication service entity to be tested 3, different validity statuses of the access point certificate and the terminal certificate can be combined in correspondence with a combination of a variety of statuses such as “valid” and “revoked” of the access point and terminal certificates. For example, the access point certificate with the status of “valid” and the terminal certificate with the status of “revoked” result in a combination, the access point certificate with the status of “revoked” and the terminal certificate with the status of “valid” result in another combination, and likely, the access point certificate with the status of “valid” and the terminal certificate with the status of “valid” result in still another combination. The correctness of the authentication service entity to be tested 3 can be tested more comprehensively by sending the certificate authentication request message with a combination of a variety of validity statuses of the certificates. For example, the statues of the certificates can include but are not limited to the two statuses of “valid” and “revoked”, other certificate statuses can be set as required in practice.

A determination as to whether the authentication result of the access point certificate and the authentication result of the terminal certificate in the certificate authentication response message returned by the authentication service entity to be tested 3 each time complies with the statuses of the sent certificates. For example, if the status of the access point certificate sent in the authentication request message is “valid” and the status of the terminal certificate is “revoked”, while the status of the access point certificate in the certificate authentication result fed back from the authentication service entity to be tested 3 is “valid” and the status of the terminal certificate is “revoked”, then it can be determined that the sent certificate statuses comply with the certificate statues resulting from authentication by the authentication service entity to be tested 3; otherwise the two do not comply with each other.

In the exemplary analysis and check processes described in the above respective procedures/steps, the testing result of the authentication service entity to be tested 3 may be a failure if any of the checks is failed, that is, the authentication service entity to be tested passes the protocol conformance testing only if all the above checks are passed. As evident from the above-described exemplary procedure, on one hand, the monitoring console 1 can compare the certificates issued by the authentication service entity to be tested 3 with the standard, on the other hand, the monitoring console 1 may analyze the authentication result of the certificates, which may be fed back from the authentication service entity to be tested 3 according to the content of the above-mentioned locally stored certificate and corresponding specifications in the standard and determines whether the secure access protocol conformance testing on the authentication service entity to be tested 3 is passed based on an analysis conclusion. If the authentication result of the certificates comply with both of the content of the locally stored certificates and corresponding specifications in the standard, then it can be determined that the secure access protocol conformance testing on the authentication service entity to be tested is passed; otherwise it is determined that the testing is failed. Since the solutions in the exemplary embodiments of the present invention can perform an item-by-item analysis on the certificates itself issued by the authentication service entity to be tested 3 and the authentication result of the certificates fed back, detailed error locating information can be provided in case the testing is failed.

It should be understood that the above-described exemplary embodiments of the methods according to the present invention can be performed by software stored on a computer-accessible medium (e.g., storage device, such as hard disk, thumb drive, floppy disk, RAM, ROM, and/or multiples and combinations thereof) being executed by a processing arrangement.

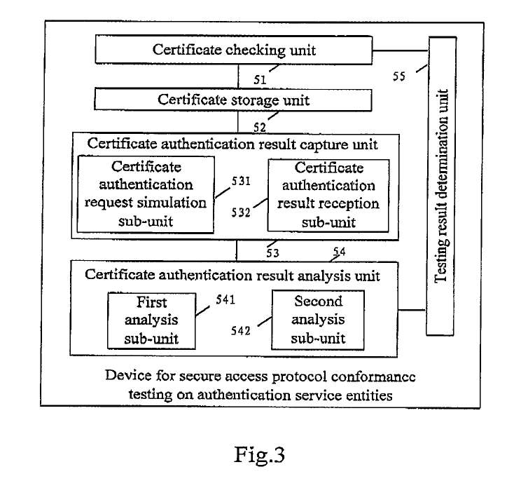

FIG. 3 illustrates a block diagram of an exemplary embodiment of a device for secure access protocol conformance testing on an authentication service entity according to the present invention. The device in this exemplary embodiment can be placed in the monitoring console 1. The exemplary device can include a certificate storage unit 52, a certificate checking unit 51, a certificate authentication result capture unit 53, a certificate authentication result analysis unit 54 and a testing result determination unit 55.

For example, the exemplary device can locally store certificates with particular validity statuses issued by the authentication service entity to be tested by the certificate storage unit 52, and the certificates issued by the authentication service entity to be tested include an access point certificate and a terminal certificate. Then, the certificate checking unit 51 may check whether the certificates stored in the storage unit 52 comply with a corresponding specification in a standard, and the testing result determination unit 55 can be notified with a check conclusion.

Furthermore, the certificate authentication result capture unit 53 can capture authentication results of the certificates, which may be sent by the authentication service entity to be tested. The certificate authentication result capture unit 53 can include a certificate authentication request simulation sub-unit 531 and a certificate authentication result reception sub-unit 532, where the certificate authentication request simulation sub-unit 531 may simulate an authentication requester (e.g., an access point) to send to the authentication service entity to be tested an authentication request message including the locally stored certificates with the particular validity statuses. The authentication service entity to be tested can authenticate the respective certificates in the authentication request message upon reception of the message, and furthermore the certificate authentication result reception sub-unit 532 can receive a certificate authentication response fed back from the authentication service entity to be tested. The certificate authentication response may include at least the authentication results of the certificates included in the authentication request message.

Thereupon, the certificate authentication result analysis unit 54 can check and analyze the authentication results of the certificates captured by the authentication result capture unit 53 according to the locally stored certificate contents and specifications in the standard, and may notify the testing result determination unit 55 with an analysis result. For example, the certificate authentication result analysis unit 54 can include a first analysis sub-unit 541 and a second analysis sub-unit 542, where the first analysis sub-unit 541 can be configured to determine by comparison whether the authentication results of the certificates comply with the locally stored certificate contents, including, e.g., at least whether validity statuses of the certificates in the certificate authentication results comply with the stored validity statuses of the certificates. The second analysis sub-unit 542 can be configured to determine by comparison whether the authentication results of the certificates comply with the corresponding specifications in the standard.

Further, the testing result determination unit 55 can determine whether the secure access protocol conformance testing on the authentications service entity to be tested is passed based on the checking conclusion of the certificate check unit 51 and the analysis conclusion of the certificate authentication result analysis unit 54. For example, if the checking conclusion of the certificate check unit is that the certificates issued by the authentication service entity to be tested comply with the corresponding specifications in the standard, and the analysis conclusion of the certificate authentication result analysis unit is that the authentication results of the certificates comply with the locally stored certificate contents and the corresponding specifications in the standard, then a testing result determined by the testing result determination unit is likely that the secure access protocol conformance testing on the authentication service entity to be tested is passed; otherwise the testing result is determined to be failed.

The exemplary embodiment of the device shown in FIG. 3 can be placed in the monitoring console 1 illustrated in FIG. 1, and when the system is in operation, the authentication service entity to be tested 3 issues respectively two access point certificates and two terminal certificates and then revokes respectively one access point certificate and one terminal certificate which have been issued, and the monitoring console 1 installs the “valid” and “revoked” access point and terminals certificates issued by the authentication service entity to be tested. An exemplary monitoring simulation program of the monitoring console 1 can be executed to send a certificate authentication request message with a combination of a variety of the validity of access point and terminal certificates to the authentication service entity to be tested 3 respectively. The monitoring console 1 can analyze an encapsulation format and certificate authentication results of a certificate authentication response message returned by the authentication service entity to be tested 3.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements, media and methods which, although not explicitly shown or described herein, embody the principles of the invention and are thus within the spirit and scope of the present invention. In addition, all publications referenced herein above are incorporated herein by reference in their entireties.

1-18. (canceled)

19. A method for testing of a secure access protocol conformance on an authentication service entity, comprising:
determining whether a certificate issued by the authentication service entity to be tested complies with a corresponding specification of a standard;
simulating an authentication requester to transmit a certificate authentication request message to the authentication service entity to be tested;
receiving a certificate authentication response provided from the authentication service entity to be tested; and
obtaining a secure access protocol conformance testing result on the authentication service entity to be tested by analyzing the certificate authentication response.

20. The method according to claim 19, wherein the certificate authentication request message is transmitted by sending a variety of certificate authentication request messages with a combination of validity statuses of the certificate.

21. The method according to claim 20, wherein the certificate comprises a terminal certificate and an access point certificate, wherein a combination of validity statuses of the certificate is a combination of a variety of statues, and wherein the variety of statues at least comprises “valid” and “revoked” of the access point certificate and the terminal certificate.

22. The method according to claim 19, wherein the certificate comprises an access point certificate and a terminal certificate, wherein the authentication requester is an access point, wherein the certificate authentication request message contains the access point certificate and a terminal certificate issued by the authentication service entity to be tested, and wherein the certificate authentication response comprises an authentication result upon authentication of the access point certificate and the terminal certificate.

23. The method according to claim 19, wherein the determining step comprises:
determining whether a value of a version number field in the certificate complies with the corresponding specification of the standard;
determining whether a length and content of a serial number field in the certificate complies with the corresponding specification of the standard;
determining whether a hashing procedure of a signature procedure field and a value of a signature procedure sub-field in the certificate complies with the corresponding specification of the standard;
determining whether values of length sub-fields and lengths of content sub-fields of a certificate issuer name field, a certificate holder name field, a certificate holder public key field and a issuer signature field in the certificate are the same; and
determining whether a length of a certificate validity period field in the certificate complies with the corresponding specification of the standard.

24. The method according to claim 19, wherein the certificate authentication response comprises a terminal certificate authentication result and an access point certificate authentication result, and wherein the certificate authentication response is analyzed by:
determining whether a version number of the certificate authentication response complies with the corresponding specification of the standard;
determining whether a value of a data length field in the certificate authentication response complies with a length of a data field;
determining by a comparison whether a content of a terminal certificate validity status field of an information field of the terminal certificate authentication result is the same as a validity status of a locally stored terminal certificate, and whether a value of a code field of the terminal certificate authentication result is within a range defined in the standard;
determining by a comparison whether a content of an access point certificate validity status field of an information field of the access point certificate authentication result is the same as a validity status of a locally stored access point certificate, and whether a value of a code field of the access point certificate authentication result is within a range defined in the standard; and
determining by a comparison whether a value of a length sub-field and a length of a content sub-field of an authentication service entity signature field in the certificate authentication response are the same, and whether they are the same as a valid length value specified in the standard.

25. The method according to claim 19, further comprising locally storing the certificate and a validity status thereof.

26. The method according to claim 19, wherein the secure access protocol is Wireless Local Area Network Authentication and Privacy Infrastructure (WAPI) protocol.

27. A method for a secure access protocol conformance testing on an authentication service entity, comprising:
storing a certificate with a particular validity status issued by the authentication service entity to be tested, and determining whether the certificate complies with a corresponding specification of a standard;
obtaining an authentication result of the certificate;
performing a conformance analysis on the authentication result according to a content of the stored certificate and the corresponding specification of the standard; and
determining whether the secure access protocol conformance testing on the authentication service entity to be tested is passed based on a determination conclusion of the certificate and an analysis conclusion of the certificate authentication result.

28. The method according to claim 27, wherein the determination step comprises, if the stored certificate issued by the authentication service entity complies with the corresponding specification of the standard, and the certificate authentication result complies with the content of the stored certificate and the corresponding specification of the standard, indicating that the secure access protocol conformance testing on the authentication service entity is passed; otherwise, indicating that the secure access protocol conformance testing on the authentication service entity to be tested is failed.

29. The method according to claim 27, wherein the authentication result is obtained by:
simulating an authentication requester to send to the authentication service entity to be tested a certificate authentication request message containing the stored certificates with the particular validity status; and
receiving a certificate authentication response provided from the authentication service entity, the certificate authentication response comprising at least an authentication result of the certificate contained in the authentication request message.

30. The method according to claim 29, wherein the certificate comprises an access point certificate and a terminal certificate, wherein the authentication requester is an access point, and wherein the certificate authentication result comprises an authentication result of the access point certificate and an authentication result of the terminal certificate.

31. The method according to claim 28, wherein a conformance of the certificate authentication result and the content of the stored certificate comprises a validity status of the certificate in the certificate authentication result complies with a validity status of the stored certificate.

32. A device for secure access protocol conformance testing on an authentication service entity, comprising:
a certificate storage arrangement configured to locally store a certificate with a particular validity status issued by the authentication service entity to be tested;
a certificate checking arrangement configured to determine whether the certificate stored in the storage unit complies with a corresponding specification of a standard;
a certificate authentication result capture arrangement configured to capture an authentication result of the certificate;
a certificate authentication result analysis arrangement configured to determine and analyze the certificate authentication result according to content of the locally stored certificate and the corresponding specification of the standard; and
a testing result determination arrangement configured to determine whether the secure access protocol conformance testing on the authentications service entity to be tested is passed based on a checking conclusion by the certificate checking arrangement and an analysis conclusion by the certificate authentication result analysis arrangement.

33. The device according to claim 32, wherein, yf the checking conclusion by the certificate checking arrangement is that the certificates complies with the corresponding specification of the standard, and the analysis conclusion by the certificate authentication result analysis arrangement is that the authentication result of the certificates complies with the contents of the locally stored certificate and the corresponding specification of the standard, then a testing result determined by the testing result determination arrangement is that the secure access protocol conformance testing on the authentications service entity to be tested is passed; and otherwise the determined testing result is failed.

34. The device according to claim 32, wherein the certificate authentication result capture arrangement comprises:
a certificate authentication request simulation sub-arrangement configured to simulate an authentication requester to send to the authentication service entity to be tested an authentication request message containing the locally stored certificate with the particular validity status; and
a certificate authentication result reception sub-arrangement configured to receive a certificate authentication response fed back from the authentication service entity to be tested, which comprises at least an authentication result of the certificate contained in the authentication request message.

35. The device according to claim 32, wherein the certificate authentication result analysis arrangement comprises:
a first analysis sub-arrangement configured to determine by a comparison whether the certificate authentication result complies with the content of the locally stored certificate, which at least comprises determining by a comparison whether a certificate validity status in the certificate authentication result complies with the a validity status of the stored certificate; and
a second analysis sub-arrangement configured to determine by a comparison whether the certificate authentication result complies with the corresponding specification of the standard.

36. The device according to claim 34, wherein the certificate comprises an access point certificate and a terminal certificate, wherein the authentication requester is an access point, and wherein the certificate authentication result comprises an authentication result of the access point certificate and an authentication result of the terminal certificate.

37. A computer accessible medium which includes software thereon for testing of a secure access protocol conformance on an authentication service entity, wherein, when a processor accesses and executes the software, the processor is configured to perform procedures comprising:
determining whether a certificate issued by the authentication service entity to be tested complies with a corresponding specification of a standard;
simulating an authentication requester to transmit a certificate authentication request message to the authentication service entity to be tested;
receiving a certificate authentication response provided from the authentication service entity to be tested; and
obtaining a secure access protocol conformance testing result on the authentication service entity to be tested by analyzing the certificate authentication response.

38. A computer accessible medium which includes software thereon for a secure access protocol conformance testing on an authentication service entity, wherein, when a processor accesses and executes the software, the processor is configured to perform procedures comprising:
storing a certificate with a particular validity status issued by the authentication service entity to be tested, and determining whether the certificate complies with a corresponding specification of a standard;
obtaining an authentication result of the certificate;
performing a conformance analysis on the authentication result according to a content of the stored certificate and the corresponding specification of the standard; and
determining whether the secure access protocol conformance testing on the authentication service entity to be tested is passed based on a determination conclusion of the certificate and an analysis conclusion of the certificate authentication result.
